(19) United States
(12) Patent Application Publication
(10) Pub. No.: US 2014/0364983 A1
(43) Pub. Date: Dec. 11, 2014

(54) Systems and Methods for Harmonizing Customer Orders and Production Capacities in Lean Manufacturing

(71) Applicants: Reiner Bildmayer, Bad Schoenborn (DE); Achim Clemens, Walldorf (DE); Stefan Hesse, Dresden (DE); Volodymyr Vasyutynskyy, Dresden (DE)

(72) Inventors: Reiner Bildmayer, Bad Schoenborn (DE); Achim Clemens, Walldorf (DE); Stefan Hesse, Dresden (DE); Volodymyr Vasyutynskyy, Dresden (DE)

(21) Appl. No.: 13/914,010

(22) Filed: Jun. 10, 2013

(51) Int. Cl. G05B 15/02

(52) U.S. Cl. CPC G05B 15/02
USPC 700/97

(57) ABSTRACT

A system, a method a computer program product for harmonizing customer orders and production capacities in lean manufacturing are provided. A capacity to produce an item identified in a received demand is determined. A production bandwidth for producing the item based on the received demand for the item is generated based on the determined capacity. A delivery time for the item described in the received demand is identified based on the generated production bandwidth.

### TECHNICAL FIELD

This disclosure relates generally to data processing and, in particular, to processing and/or planning of customer sales orders against production capabilities.

### BACKGROUND

Conventional manufacturing processes management systems implement material requirements planning (“MRP”) methodologies and systems, which provide production planning and inventory control. The MRP systems are typically software based, and are designed to simultaneously meet the following objectives: (1) ensure that materials are available for production and products are available for delivery to customers; (2) maintain the lowest possible material and product levels in a store; (3) plan manufacturing activities, delivery schedules and purchasing activities; and (4) monitor and control production activity, which, in some cases, may be necessary to achieve objectives (1)-(3).

MRP systems typically help businesses maintain low inventory levels and can be used to plan manufacturing, purchasing and/or delivering activities. Some of the objectives of a business in the marketplace is to control types and quantities of materials the business purchases, plan which products will be produced and in what quantities, and ensure that they are able to meet current and future customer demands, preferably, at the lowest possible cost. An imprudent decision with regard to any of the above objectives can be costly for the business (e.g., a purchase of insufficient quantities of an item used in manufacturing (or the wrong item) can lead to inability to meet contract obligations; whereas, a purchase of excessive quantities can lead to waste of resources, money, materials, etc.; additionally, a supply shortfall maybe possible if the required quantity of rare material exceeds the ordered quantity, which can lead to extraordinary higher costs if the quantity of rare material is globally limited (e.g., rare earth metals, etc.) and all mined capacity is already booked; etc.). MRP systems help businesses answer questions with regard to what, how many, and when products/items may be required. Input to MRP systems typically include end item (or items) being created, how much is required at a time, when the quantities are required to meet demand, shelf life of stored materials, inventory status records (or stock), details of the materials, components and sub-assemblies required to make each product, restraints and directions to produce the end items. The MRP system can produce various reports, which can include recommended production schedules and recommended purchasing schedule”.

However, existing MRP systems are typically based on a fixed upper limit of capacity and do not allow flexibility in changing demand for a product, which leads to wasted resources/materials (or in the alternative, lack of resources/materials), improper scheduling, loss of income, and/or various other issues. Further, manufacturing companies may need to compete with regard to delivery times and thus, if they cannot adapt their capacity supply to current demand (e.g., decrease or increase in demand), the companies may lose sales, orders, customers, etc.

### SUMMARY

In some implementations, the current subject matter relates to a computer-implemented method for harmonizing customer orders and production capacities in lean manufacturing. The method can include determining a capacity to produce an item identified in a received demand, generating, based on the determining, a production bandwidth for producing the item based on the received demand for the item, and identifying, based on the generated production bandwidth, a delivery time for the item described in the received demand. At least one of the determining, the generating, and the identifying can be performed on at least one processor.

In some implementations, the current subject matter can include one or more of the following optional features. The production bandwidth can be determined based on at least one of the following: a quantity of the item demanded, an available production capacity to produce the item, and at least one existing demand to produce another item. The production bandwidth can be measured in a number of items produced during a predetermined period of time. The generating can include converting a quantity of the item identified in the received demand into the production bandwidth. The identified delivery time can be a time by which the item is requested to be delivered in the received demand. The identified delivery time can be determined based on an available production capacity to produce the item.

Computer program products are also described that comprise non-transitory computer readable media storing instructions, which when executed one or more data processor of one or more computing systems, causes at least one data processor to perform operations herein. Similarly, computer systems are also described that may include one or more data processors and a memory coupled to the one or more data processors. The memory may temporarily or permanently store instructions that cause at least one processor to perform one or more of the operations described herein. In addition, methods can be implemented by one or more data processors either within a single computing system or distributed among two or more computing systems.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for harmonizing customer demand for a product/service against production capacities, according to some implementations of the current subject matter;

FIG. 2 illustrates an exemplary system for harmonizing customer orders against production capacities, according to some implementations of the current subject matter;

FIG. 3 illustrates an exemplary method performed by the system shown in FIG. 2 for harmonizing customer orders and production capacities based on production bandwidth, according to some implementations of the current subject matter;

FIG. 4 illustrates an exemplary method for performing an available-to-promise check, according to some implementations of the current subject matter;

FIG. 5 illustrates an exemplary method, according to some implementations of the current subject matter; and

FIG. 6 illustrates an exemplary system, according to some implementations of the current subject matter.

### DETAILED DESCRIPTION

To address the above-described and potentially other deficiencies of currently available solutions, one or more implementations of the current subject matter provide methods, systems, articles or manufacture, and the like that can, among other possible advantages, provide systems and methods for providing systems, methods, and computer program products for providing a flexible approach to harmonizing customer demand against production capacities in achieving lean manufacturing. Lean manufacturing or lean production can be referred to as a production principle, where an expenditure of resources for any goal other than creation of a value for the end customer to be wasteful.

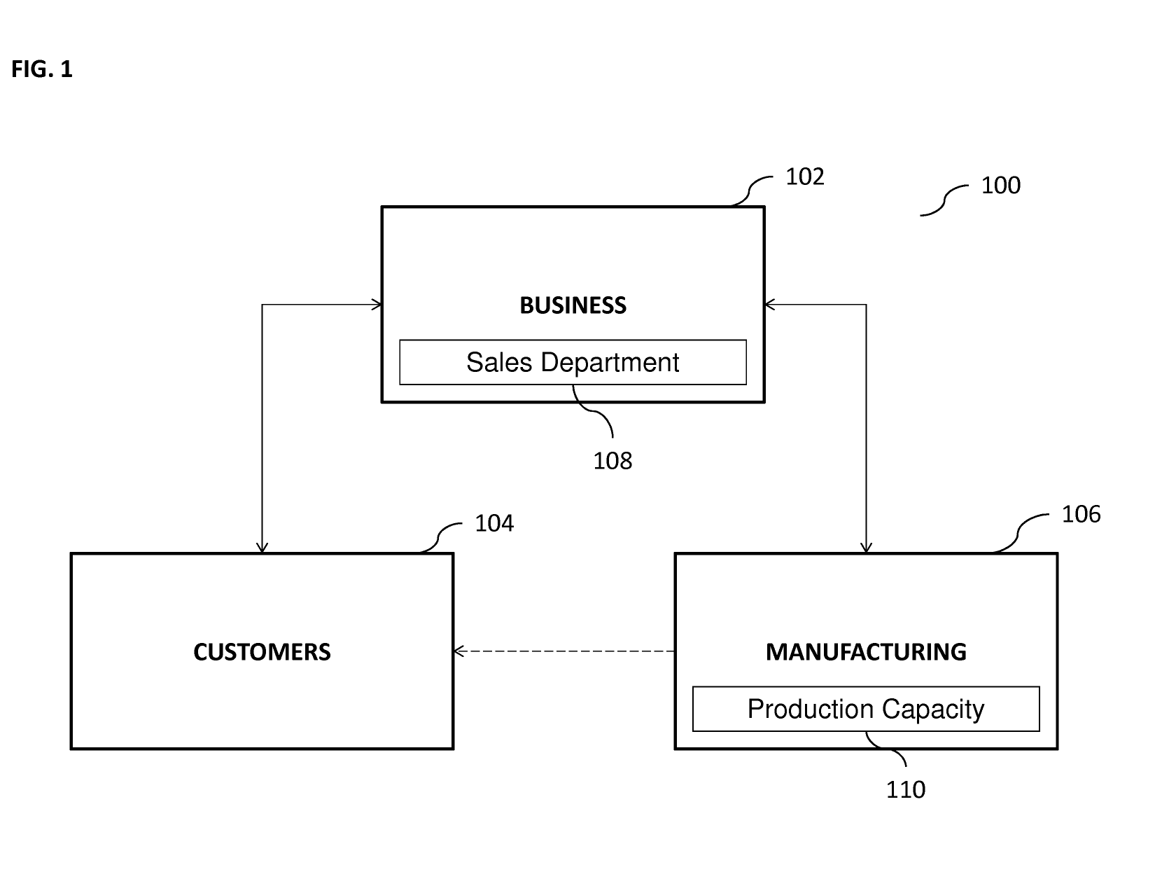

FIG. 1 illustrates an exemplary system 100 for harmonizing customer demand for a product/service against production capacities, according to some implementations of the current subject matter. The system 100 includes a business 102, customers 104 of the business 102, and manufacturing 106. The business 102 can offer to sell (or provide) products and/or services to its customers 104. The business 102 can offer to sell a plurality of different products and/or services to its customers 104. The customers 104 can purchase products and/or services offered to them by the business 102 by paying the price for products and/or services that may be selected by the customers 104 for purchase. The price can be a listed price, agreed-upon price, negotiated price, discounted price, and/or any other price (and/or terms and conditions associated with the purchase). The business 102 can, through, for example, its sales department 108, request the manufacturing 106 to manufacture the products and/or services (if any) and supply them to the business 102 for providing to the customers 104 (and/or directly supply them to the customers 104, as shown by the dashed line in FIG. 1). The manufacturing 106 can include factories, plants, warehouses, suppliers, labor workforce, etc. that can be involved in the making, storage, supply, etc. of a product/service.

Manufacturing process can be characterized by a particular production capacity 110 (e.g., a number of product units that it can make), which can be limited, for example, by the availability of parts, labor, costs, etc. as well as a demand for a particular product/service from the business 102. For example, if a demand for a product/service is low, the manufacturing capacity of that product/service can be appropriately lowered, so as not to create waste. The demand for a product/service can be generated by the business 102 and can be based on a number of sales orders for that product/service that the business 102 can receive from the customers 104 and can strive to fulfill.

One of the goals of a fulfillment process is to schedule demand (both sales and internal) against capacity supply by the manufacturing, thus, the fulfillment process is based on a principle of a demand following supply. The current subject matter system can appropriately determine demand for a product/service based on production limitations, thereby allowing reduction of manufacturing costs (e.g., additional working shifts by the labor force required to produce the product), reduction in waste of resources, decrease in loss of revenue, etc. The current subject matter system can also enable fulfillment of the demand for a particular product/service, thus, integrating a principle of a supply following demand.

Some of the advantages of the current subject matter system include use of manufacturing capacities to perform a check on whether it is possible to fulfill a particular order at a particular time. A parameter indicative of quantities of products that are not consumed during a particular time period and expiring at that period's end is used by the conventional systems as a hard constraint. Conventional systems do not allow flexibility and do not perform manual interaction/overrule. In contrast, the current subject matter system can enable a quantity conversion, i.e., a conversion from sales order attributes (e.g., sales price, sales quantity, etc.) into a unit of measure in a bandwidth definition, which is discussed below.

Another advantage of the current subject matter system is that, unlike the conventional MRP systems, which are based on a single criterion of the capacity defined as produced quantity per time unit, the current subject matter system can allow definition of multiple production criteria (e.g., resource, personnel and/or material availability, price, priority of customer order, etc.). This can allow for a better and more flexible alignment of the planning with demands of the production.

Further, conventional systems use sales quantities of a product/service to determine a possible delivery date of the product/service to the customer based on capacities per quantities. Using conventional systems, a company is able to produce a certain quantity of various products in a particular period of time, where the quantity can be measured in pieces and the period of time can be any period of time (e.g., a day, a week, a month, a year, etc.). Various products can refer to any type of products. For example, the quote and demands can be as follows:
Week 27: Quota: 400 pieces; existing demand: 50 pieces of type A, 200 pieces of type B, and 150 pieces of type C;
Week 28: Quota: 450 pieces; existing demand: 10 pieces of type A, 300 pieces of type C, 140 pieces of type E;
Week 29: Quota: 450 pieces; existing demand: 120 pieces of type F.

In the conventional systems, quantities of each type of piece are added until the maximum of the offered quota in a particular week is reached. The quota in the above example is measured in pieces per week. Conventional systems do not take into account any other factors. In contrast, the current subject matter system can use additional factors/measurements, e.g., an aspect of a product to be produced within a particular time period, based on a certain bandwidth.

The current subject matter system can be used to support a model of lean production and “breathing” factory (i.e., where the capacities of the production do not have a fixed maximum and can be set flexibly). Some of advantages of such lean principle can include flexibility, quicker reaction on demands of production and customers, reduced costs due to less waste of resources, etc.

Modern lean approaches typically target so-called breathing manufacturing, where the capacities of the production do not have a fixed maximum, but can be set flexibly (e.g. staff, purchase of raw material) to allow better meeting of the customer demands or current resource situation in the production. Also, in these approaches the capacities are bound to proper limited production criteria, e.g., by material, resource and personnel availability, product properties, supplier contracts etc. In modern approaches, short delivery times and superior delivery reliability typically provide competitive advantage. Lean process patterns can serve as basis for production and supply chain management.

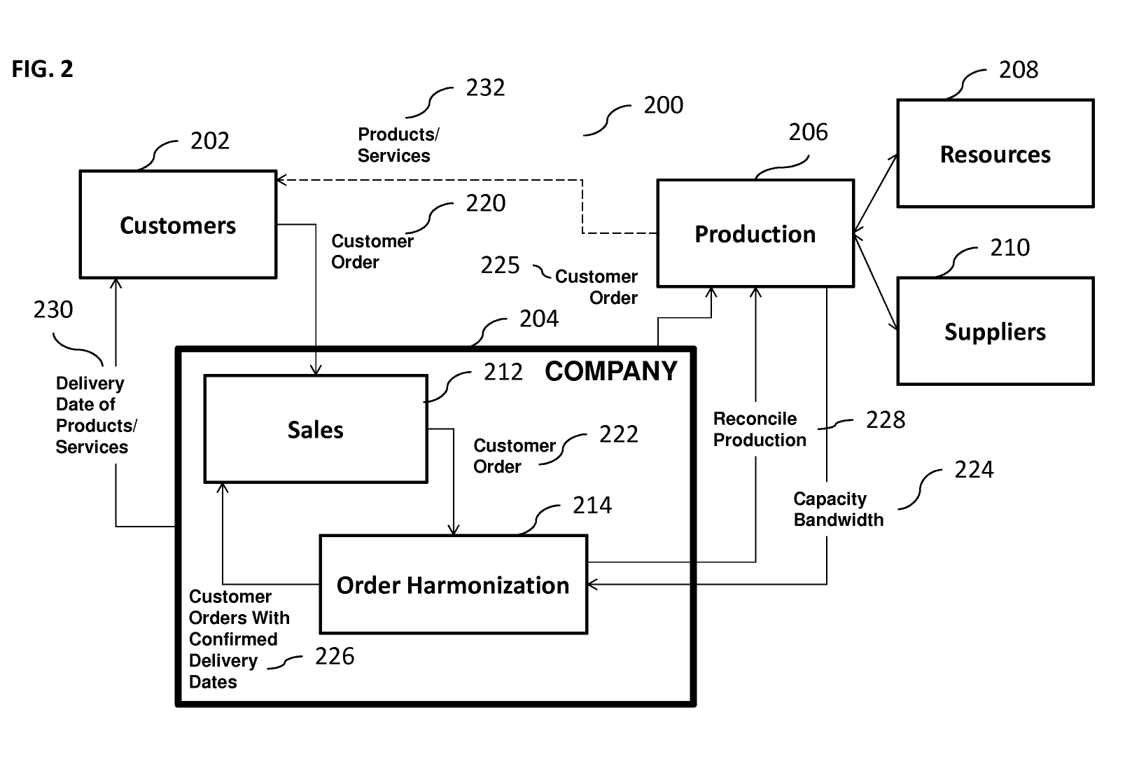

FIG. 2 illustrates an exemplary system 200 for harmonizing customer orders against production capacities, according to some implementations of the current subject matter. The system 200 can provide communication capabilities between a company 204, customers 202 of the company 204, and production 206 (which can be a factory, a production plant, external suppliers or production services, and/or any other facility that can be involved in manufacturing, business, research and development, and/or any other functionalities). The production 206 can be part of the company 204 and/or separate (e.g., out-sourced) from the company 204. The company 204 can provide its customers 202 with an ability to order and purchase various products and/or services that can be offered by the company 204. The customers 202 can order/purchase company's products/services by placing a customer order 220 through the company's sales department 212. The customer order 220 can specify a particular product/service that the customer desires to purchase from the company 204, a quantity of the product/service, various options associated with the product/service, desired delivery date (if available), purchase price (if available), and/or any other particulars of the order.

The sales department 212 of the company 204 can receive the customer order 220 and process it appropriately. Processing of the order can involve assignment of an internal company reference number to the order, determination of an availability of the product/service, and/or any other actions. The sales department 212 can then pass the processed customer order (as order 222) to the order harmonization 214 to reconcile with production capacities (as illustrated by 228 in FIG. 2) in order to generate a customer order 226 with a confirmed delivery due date. The confirmed order 226 can then be passed back to the sales department 212, which, in turn, can inform the customer 202. The company 204 can provide the customers 202 with a confirmed delivery date of products/services (as shown by 230 in FIG. 2) and subsequently, provide the customers 202 with the ordered products/services. Alternatively, the production 206 can provide customers 202 with the ordered products/services (as shown by 232 in FIG. 2). Further, the company 204 and/or the production 206 can simply provide the customers 202 with the ordered products/services without confirming the delivery date (e.g., when confirming the delivery date will take longer than delivering actual products/services).

The production 206 can interact with the company 204 to inform the company 204 as to its capacity production bandwidth 224 based on the received customer order (or orders) 225 from the company 204. The production 206 can also interact with various resources 208 (e.g., labor resources, financial resources, etc.) and suppliers 210 (e.g., raw materials, parts, etc.). Such interaction can include providing by the production 206 information to resources/suppliers 208, 210 about resources/suppliers needed by the production in order to fulfill customer order and receiving responses from resources/suppliers 208, 210, which can include, for example, an indication of availability/unavailability of resources/suppliers, pricing, costs, requirements, etc.

In some implementations, the capacity production bandwidth 224 can be applied to a capacity of any kind of production resources. In its turn, capacity can be expressed in quantities (e.g., pieces, money units, and/or any other units of measure) per time (e.g., per day, per week, per month, and/or any other predetermined time period). The capacity can be assigned to a certain factory or plant, a production line, a product/service, and/or any other aspect of production. The bandwidth can include at least one of the following parameters: a maximum capacity, an average capacity, and a minimum capacity. The maximum capacity can be representative of sales orders that can potentially exceed production capabilities (e.g., the production factory can produce a maximum of 100 cars per month, whereas the customer order is for 150 cars). The maximum capacity parameter can be applicable in rare cases, such as when the customer orders are backed by some form of a guarantee, etc. The average capacity parameter can represent what is expected on average in a “normal production mode.” For example, a company can define its “normal production mode” as eight production hours per day, five days a week, or 40 hours per week. In some implementations, the normal production mode can refer to a quantity of hours (or any other period of time), during which the company can run in a profitable mode and/or a healthy mode (e.g., without a loss (such as, financial, personnel, technological, etc., losses). Increasing production period of time (e.g., from 8 hours to 10 hours per day) as a way of providing additional possible capacities (“breathing in”) can raise further income, however, such increase might be possible for a short periods of time (e.g., during a significant increase in production demand, such as when an unusual number of customer orders is received). Working hours are not the only instrument that can be adjusted and other resources can be regulated by capacity bandwidth. Reducing or not “filling up” the normal production mode might not be healthy for the company (e.g., causing a company to sustain a loss). Thus, the company may wish to save resources (e.g., financial, technological, etc.) during normal production mode or an overload production times to allow the company to survive in such times. The minimum capacity parameter can refer to situations where sales orders do not meet the minimum production volume, thereby requiring special sales promotions, adjustments in production volume, reduction or re-adjustment of production crew's schedule, etc.

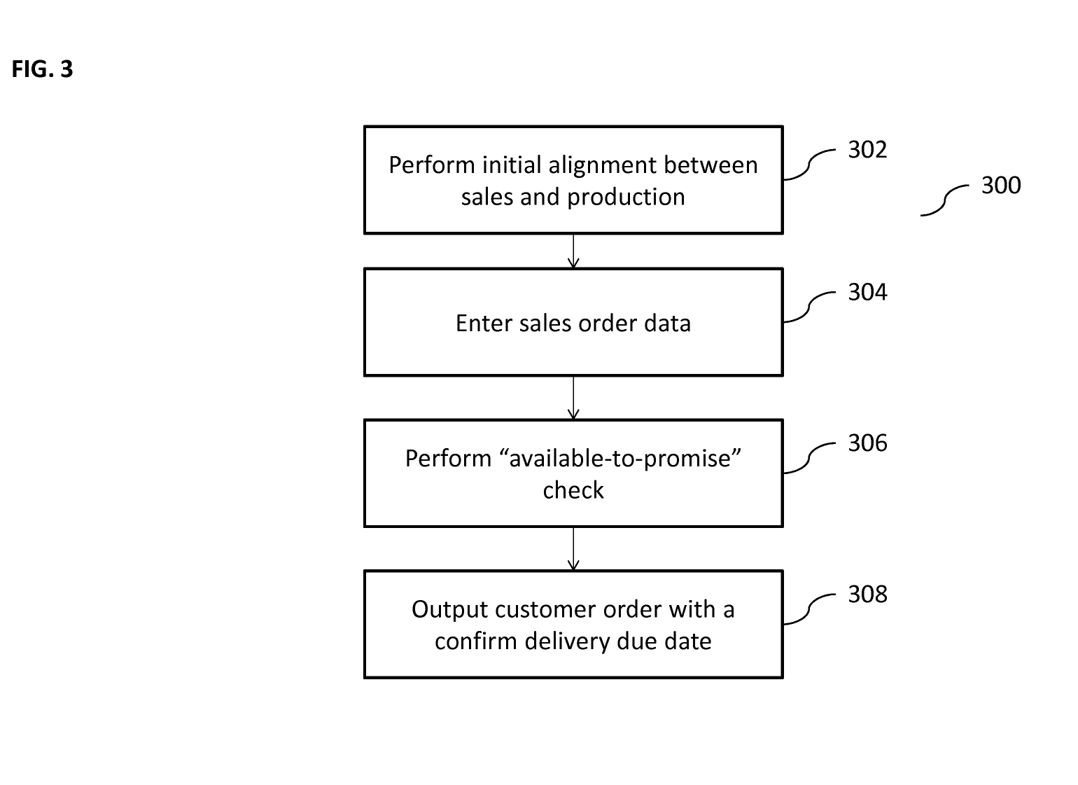

FIG. 3 illustrates an exemplary method 300 performed by the system 200 for harmonizing customer orders and production capacities based on production bandwidth, according to some implementations of the current subject matter. At 302, an initial alignment between sales department 212 of the company 204 (shown in FIG. 2) and production 206 (also shown in FIG. 2) can be performed. The alignment can include the sales department 212 providing information concerning customer orders to the production 206. This information can include specifics concerning a particular product (or service) that the customer is ordering, quantity desired by the customer, custom features of the product, sale price (if so desired), requested delivery date, customer information, and/or any other data. The production 206 can provide information about its production bandwidth. The production bandwidth can be limited by various constraints, e.g., suppliers limitations, parts, operational hours, labor force availability, rate of production, costs, etc., and/or any combination of such constraints. In some implementations, the constraints on the production and on the bandwidths can be predetermined by the production, thereby allowing definition of criteria indicating how much can be sold (produced) per a particular time unit. These criteria can be measured in different units, such as, revenue per month, added product height per week, etc. It is usual to have more than one criterion.

Once the sales department 212 (shown in FIG. 2) and the production 206 (shown in FIG. 2) agree on the production bandwidths, sales order data can be entered into (and/or requested from others systems) the production system, at 304. The sales order data can include, for example, customer information, product (or service) information as requested by the customer, quantity of the product (or service), requested delivery date, optional product features, and/or any other information. This information can be necessary for the production to manufacture an appropriate product that will fulfill the customer's sales order.

At 306, an “available-to-promise” check can be performed by the system 200 (shown in FIG. 2). The available-to-promise check can include checking available stock, expected supply and demand, capacity constraints, and/or any other factors. The available-to-promise check can be based on a principle of the product demand following product supply.

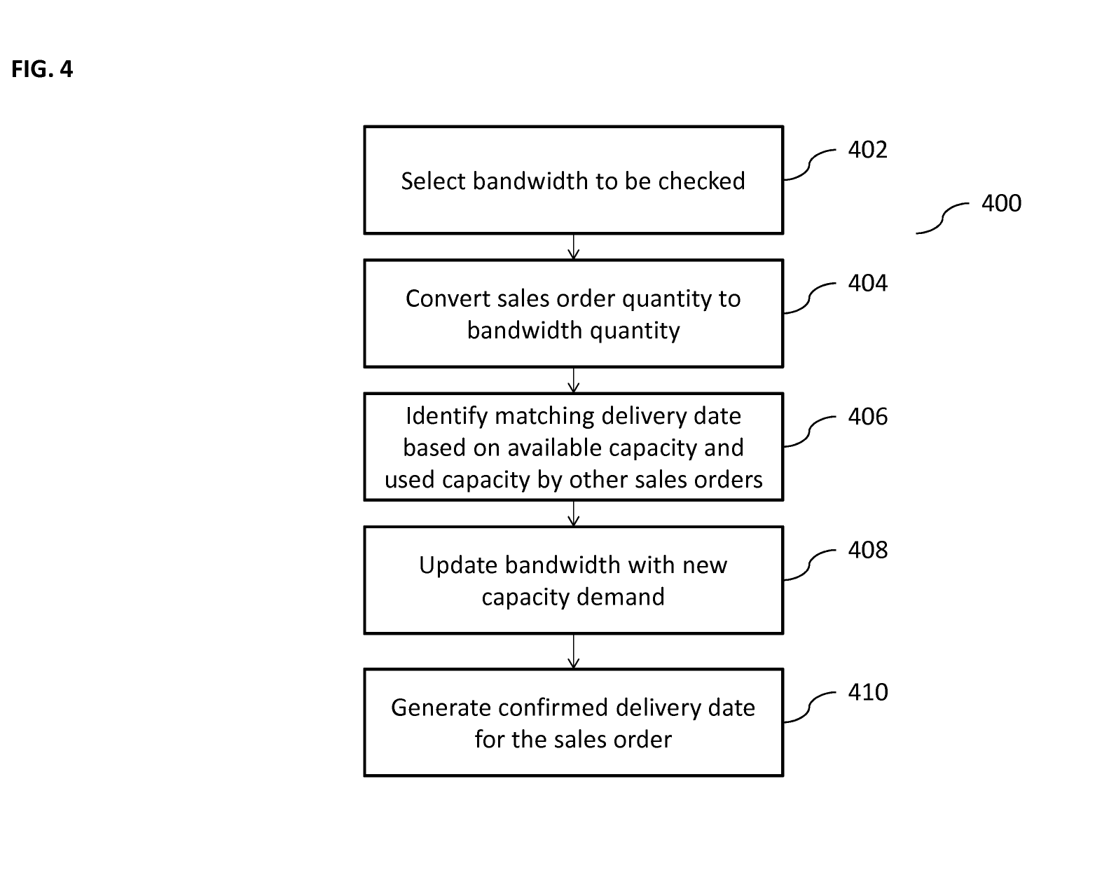

FIG. 4 illustrates an exemplary method 400 for performing an available-to-promise check, according to some implementations of the current subject matter. At 402, a particular bandwidth can be checked. The bandwidth can relate to a capacity of a particular production plant to manufacture a product outlined in the customer sales order. For example, a particular production plant can manufacture 100 cars per month provided it is fully staffed with 500 workers (where each worker or a group of workers can specialize on a particular area of a car, for example) each working 8-hour work shift per 24 hours per day and assuming it has adequate supply of parts, materials, and fully operational. Another example of a bandwidth that can be checked includes supplier's ability to timely provide resources, e.g., raw materials, parts, equipment, etc. Other types of bandwidths can be checked as well.

At 404, the quantity of the product requested in the sales order by the customer can be converted to a bandwidth quantity. Alternatively, or in addition to, resource limitations, labor allocation, and/or any other factors can be converted into the bandwidth quantity. This can be expressed in number of units of the ordered product per a predetermined time unit (e.g., day, week, month, year, and/or any other predetermined time period). For example, 50 cars per month can be the bandwidth quantity based on the sales order that has been submitted by the customer.

At 406, a matching delivery date can be identified or determined based on available capacities of the production plant as well as production plant capacities that may be already used by other existing sales orders. As the production plant that the company may be using can accommodate production of products in other sales orders, the capacity of the production plant can be reduced, thereby extending the delivery date of the products outlined in the customer order further.

At 408, the bandwidth of the production plant can be updated using the new capacity demand. This update can affect future sales orders, as the capacity to produce a particular product outlined in the future sales orders can be reduced in view of the production demands generated by existing orders.

At 410, a confirmed delivery date for the product(s) in the customer sales order can be generated. Referring back to FIG. 3, the confirmed delivery date generated at 410, can be provided to the sales department 212 (shown in FIG. 2) and eventually to the customer 202 (shown in FIG. 2). In some implementations, the methods 300 (shown in FIG. 3) and 400 (shown in FIG. 4) can be performed in real time, including analysis of sales orders, production capacities, alignment of sales orders with production capacities, and performance of the available-to-promise check. This way, the customer can receive an instantaneous information about the confirmed delivery date.

The following example illustrates an exemplary implementation of methods 300 (shown in FIG. 3) and 400 (shown in FIG. 4) as performed by the system 200 (shown in FIG. 2). A company can determine that it can produce sales orders with a volume of [symbol] 700,000 per week. Sales orders can reduce this capacity by a sales price and a determination of a confirmed delivery date can be based on the following time sequence:
Week 1—supply: [symbol] 700,000; existing demand: [symbol] 700,000
Week 2—supply: [symbol] 700,000; existing demand: [symbol] 550,000
Week 3—supply: [symbol] 700,000; existing demand: [symbol] 200,000

Assuming that the next sales order includes a price of [symbol] 200,000, thus, the delivery date for that order can be assigned to Week 3. In some implementations, it can be possible that a user can overrule the system's calculation and change the confirmed week to Week 2 through various communications/collaboration with production planning and/or production execution. This way, the flexible dates for production can be defined and the production bandwidths can be confirmed. In another exemplary implementations, the customer can require the delivery in Week 2, thus, the bandwidth can be set higher on [symbol] 750,000 in Week 2. As such, flexible dates and/or firm production dates are possible.

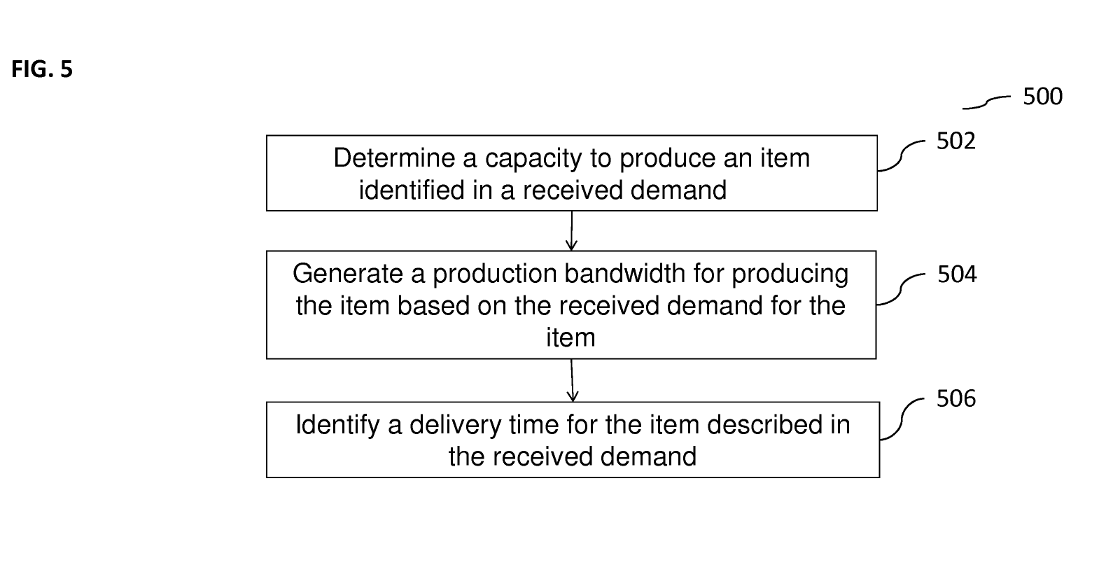

FIG. 5 illustrates an exemplary method 500, according to some implementations of the current subject matter. At 502, a capacity to produce an item identified in a received demand can be determined. At 504, a production bandwidth for producing the item based on the received demand for the item can be generated. At 506, a delivery time for the item described in the received demand can be identified based on the generated production bandwidth.

In some implementations, the current subject matter can include one or more of the following optional features. The production bandwidth can be determined based on at least one of the following: a quantity of the item demanded, an available production capacity to produce the item, and at least one existing demand to produce another item. The production bandwidth can be measured in a number of items produced during a predetermined period of time. The generating can include conversion of a quantity of the item identified in the received demand into the production bandwidth. The identified delivery time can be a time by which the item is requested to be delivered in the received demand. The identified delivery time can be determined based on an available production capacity to produce the item.

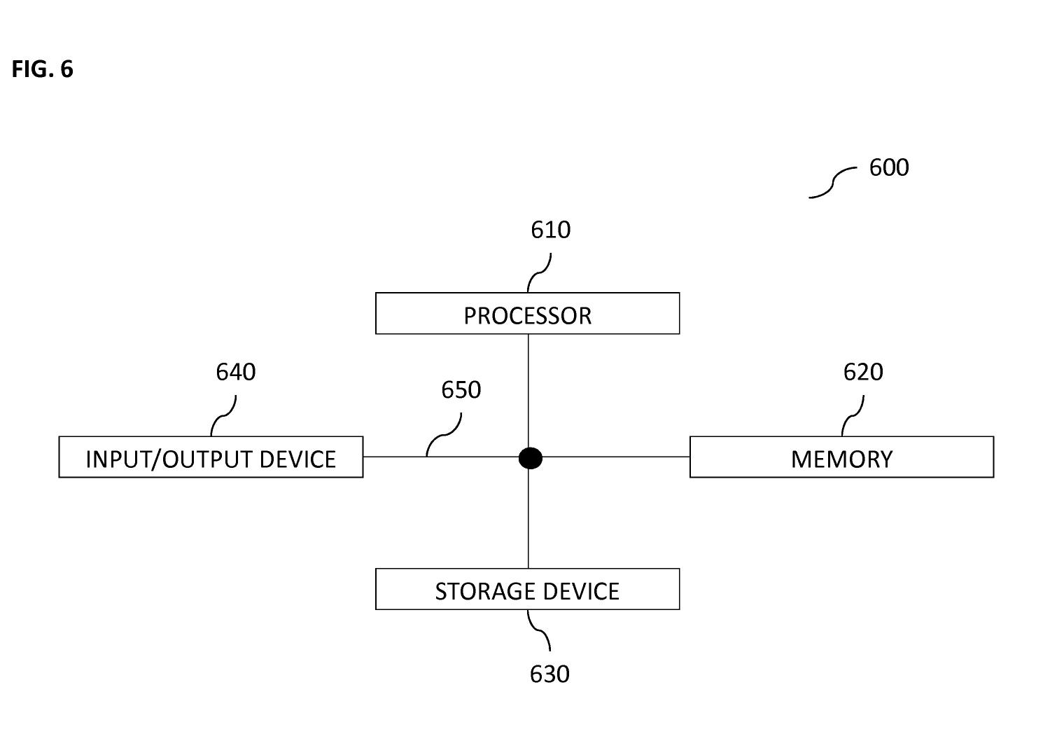

In some implementations, the current subject matter can be configured to be implemented in a system 600, as shown in FIG. 6. The system 600 can include a processor 610, a memory 620, a storage device 630, and an input/output device 640. Each of the components 610, 620, 630 and 640 can be interconnected using a system bus 650. The processor 610 can be configured to process instructions for execution within the system 600. In some implementations, the processor 610 can be a single-threaded processor. In alternate implementations, the processor 610 can be a multi-threaded processor. The processor 610 can be further configured to process instructions stored in the memory 620 or on the storage device 630, including receiving or sending information through the input/output device 640. The memory 620 can store information within the system 600. In some implementations, the memory 620 can be a computer-readable medium. In alternate implementations, the memory 620 can be a volatile memory unit. In yet some implementations, the memory 620 can be a non-volatile memory unit. The storage device 630 can be capable of providing mass storage for the system 600. In some implementations, the storage device 630 can be a computer-readable medium. In alternate implementations, the storage device 630 can be a floppy disk device, a hard disk device, an optical disk device, a tape device, non-volatile solid state memory, or any other type of storage device. The input/output device 640 can be configured to provide input/output operations for the system 600. In some implementations, the input/output device 640 can include a keyboard and/or pointing device. In alternate implementations, the input/output device 640 can include a display unit for displaying graphical user interfaces.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
determining a capacity to produce an item identified in a received demand;
generating, based on the determining, a production bandwidth for producing the item based on the received demand for the item; and
identifying, based on the generated production bandwidth, a delivery time for the item described in the received demand;
wherein the at least one of the determining, the generating, and the identifying is performed on at least one processor.

2. The method according to claim 1, wherein the production bandwidth is determined based on at least one of the following: a quantity of the item demanded, an available production capacity to produce the item, and at least one existing demand to produce another item.

3. The method according to claim 1, wherein the production bandwidth is measured in a number of items produced during a predetermined period of time.

4. The method according to claim 3, wherein the generating further comprises converting a quantity of the item identified in the received demand into the production bandwidth.

5. The method according to claim 1, wherein the identified delivery time is a time by which the item is requested to be delivered in the received demand.

6. The method according to claim 1, wherein the identified delivery time is determined based on an available production capacity to produce the item.

7. A computer program product comprising a machine-readable medium storing instructions that, when executed by at least one programmable processor, cause the at least one programmable processor to perform operations comprising:
determining a capacity to produce an item identified in a received demand;
generating, based on the determining, a production bandwidth for producing the item based on the received demand for the item; and
identifying, based on the generated production bandwidth, a delivery time for the item described in the received demand.

8. The computer program product according to claim 7, wherein the production bandwidth is determined based on at least one of the following: a quantity of the item demanded, an available production capacity to produce the item, and at least one existing demand to produce another item.

9. The computer program product according to claim 7, wherein the production bandwidth is measured in a number of items produced during a predetermined period of time.

10. The computer program product according to claim 9, wherein the generating further comprises converting a quantity of the item identified in the received demand into the production bandwidth.

11. The computer program product according to claim 7, wherein the identified delivery time is a time by which the item is requested to be delivered in the received demand.

12. The computer program product according to claim 7, wherein the identified delivery time is determined based on an available production capacity to produce the item.

13. A system comprising:
at least one programmable processor; and
a machine-readable medium storing instructions that, when executed by the at least one programmable processor, cause the at least one programmable processor to perform operations comprising:
determining a capacity to produce an item identified in a received demand;
generating, based on the determining, a production bandwidth for producing the item based on the received demand for the item; and
identifying, based on the generated production bandwidth, a delivery time for the item described in the received demand.

14. The system according to claim 13, wherein the production bandwidth is determined based on at least one of the following: a quantity of the item demanded, an available production capacity to produce the item, and at least one existing demand to produce another item.

15. The system according to claim 13, wherein the production bandwidth is measured in a number of items produced during a predetermined period of time.

16. The system according to claim 15, wherein the generating further comprises converting a quantity of the item identified in the received demand into the production bandwidth.

17. The system according to claim 13, wherein the identified delivery time is a time by which the item is requested to be delivered in the received demand.

18. The system according to claim 13, wherein the identified delivery time is determined based on an available production capacity to produce the item.
